(19) United States
(12) Patent Application Publication
(10) Pub. No.: US 2026/0018781 A1
(43) Pub. Date: Jan. 15, 2026

(54) TERMINAL ANTENNA AND ELECTRONIC DEVICE

(71) Applicant: Honor Device Co., Ltd., Shenzhen (CN)

(72) Inventors: Tiezhu LIANG, Shenzhen (CN); Dawei ZHOU, Shenzhen (CN); Xiaotao CAI, Shenzhen (CN); Guolong WANG, Shenzhen (CN)

(73) Assignee: Honor Device Co., Ltd., Shenzhen (CN)

(21) Appl. No.: 18/992,387

(22) PCT Filed: Sep. 4, 2023
(86) PCT No.: PCT/CN2023/116691

§ 371 Date: Jan. 8, 2025

(30) Foreign Application Priority Data
Nov. 4, 2022 (CN) 202211380028.3

(51) Int. Cl. H01Q 1/24; H01Q 5/20; H01Q 5/314

(52) U.S. Cl. CPC H01Q 1/243; H01Q 5/20; H01Q 5/314

(57) ABSTRACT

The application discloses a terminal antenna and an electronic device. The terminal antenna is used in the electronic device, the electronic device is provided with a metal frame, and the metal frame is provided with a first gap and a second gap. A metal segment between the first gap and the second gap forms a first radiator, and the first radiator and other metal segment are not connected to each other. The antenna includes the first radiator. A first electrical connection point, a second electrical connection point, and a third electrical connection point are sequentially provided on the first radiator. The first electrical connection point is coupled to a feed through a first tuning component, the second electrical connection point is coupled to a reference ground, and the third electrical connection point is coupled to the reference ground through a second tuning component.

### CROSS-REFERENCE TO RELATED APPLICATIONS

This application is a National Stage of International Application No. PCT/CN2023/116691, filed on Sep. 4, 2023, which claims priority to Chinese Patent Application No. 202211380028.3, filed on Nov. 4, 2022, both of which are hereby incorporated by reference in their entireties.

### TECHNICAL FIELD

This application relates to the field of antenna technologies, and in particular, to a terminal antenna and an electronic device.

### BACKGROUND

An electronic device may implement a wireless communication function by using antennas disposed therein. Some of the antennas may be disposed on a side of the electronic device for radiation.

Usage scenarios of the electronic device include free space, holding by a hand, and other scenarios. Therefore, in these scenarios, the antennas disposed on the side all need to be capable of delivering good radiation performance, so as to support wireless communication quality of the electronic device.

### SUMMARY

Embodiments of this application provide a terminal antenna and an electronic device. The antenna has better performance in free space and on hand phantoms. Even if disposed on a side of the electronic device, the antenna can also support the electronic device for good-quality wireless communication in various scenarios.

To achieve the foregoing objective, the following technical solutions are used in the embodiments of this application.

According to a first aspect, a terminal antenna is provided. The terminal antenna is used in an electronic device, the electronic device is provided with a metal frame, and the metal frame is provided with a first gap and a second gap. A metal segment between the first gap and the second gap forms a first radiator, and the first radiator and other metal segment outside the first gap and the second gap are not connected to each other. The antenna includes the first radiator, where a first electrical connection point, a second electrical connection point, and a third electrical connection point are sequentially provided on the first radiator. The first electrical connection point is coupled to a feed through a first tuning component, the second electrical connection point is coupled to a reference ground, and the third electrical connection point is coupled to the reference ground through a second tuning component.

Thus, through sequential disposing of the foregoing feed and ground points on the metal-frame antenna, a CM mode and a DM mode can both be excited, thereby delivering good radiation performance both in free space and on hand phantoms.

Optionally, the first tuning component includes a first capacitor. In this way, connecting a capacitor in series on a feeder link can excite a left-handed mode.

Optionally, the second tuning component includes at least one type of the following: a capacitor or an inductor.

Optionally, the second tuning component includes at least one second capacitor, and a capacitance of the second capacitor is determined depending on an operating band. When the operating band of the antenna covers low frequencies, the capacitance of the second capacitor is included in a range of 0 pF to 8 pF; and when the operating band of the antenna covers medium-high frequencies, the capacitance of the second capacitor is included in a range of 0 pF to 5 pF.

Optionally, the second tuning component includes at least one first inductor, and an inductance of the first inductor is determined depending on an operating band. When the operating band of the antenna covers low frequencies, the inductance of the first inductor is included in a range of 10 nH to 82 nH; and when the operating band of the antenna covers medium-high frequencies, the inductance of the first inductor is included in a range of 5 nH to 27 nH.

This solution provides several examples of disposing schemes for the second tuning component. For example, a capacitor, an inductor, or another component may be disposed as the second tuning component depending on the operating band. Thus, the DM mode is excited, and a longitudinal eigenmode on the ground is well excited, thereby achieving good radiation performance.

Optionally, the second tuning component includes at least two paths, and during operation of the antenna, at least one of the at least two paths is selected, by using a switch, for connection. One second capacitor or one first inductor is disposed on each of the at least two paths. In this manner, through disposing of the switch, a plurality of capacitors or inductors can be disposed. Thus, in a different scenario or operating band, switching to a corresponding path is performed to connect to a corresponding second capacitor or first inductor, so that the operating band is covered by a corresponding DM mode in free space.

Optionally, the antenna further includes a third tuning component, one end of the third tuning component is connected to the first electrical connection point or a vicinity of the first electrical connection point, and the other end of the third tuning component is connected to the reference ground. The third tuning component includes at least two third capacitors, where each of the third capacitors corresponds to a path, and capacitances of third capacitors on different paths are different. During operation of the antenna, at least one of paths corresponding to the at least two third capacitors is selected, by using a switch, for connection.

This example provides an implementation of disposing the switch component on the feeder link to switch between the paths. For example, the third tuning component may be connected in parallel to the first electrical connection point. For another example, the third tuning component may be connected in parallel to the radiator near the first electrical connection point. Through switching between the different paths of the third tuning component for connection, the capacitors with the different capacitances can be connected to the feeder link, or the radiator near the feeder link. In this way, a frequency band covered by the CM mode is switched.

Optionally, the first radiator is equally divided into a first part, a second part, and a third part, and the second part is located between the first part and the third part. The first electrical connection point is provided at any position of the first part, the second electrical connection point is provided at any position of the second part, and the third electrical connection point is provided at any position of the third part.

Optionally, the first electrical connection point is provided at an end that is of the first part and that is away from the second part, and the third electrical connection point is provided at an end that is of the third part and that is away from the second part.

Optionally, during operation of the antenna, a first resonance and a second resonance are excited, where a frequency of the first resonance is lower than that of the second resonance, the first resonance is excited in the common mode CM, and the second resonance is excited in the differential mode DM. Based on this solution, the operating band is mainly covered by the DM mode in the free space, and the CM mode may be excited in a low frequency direction of the DM mode. Thus, in hand only scenarios, even if a resonance shifts toward higher frequencies due to holding by hands, the CM mode can also fall within the operating band, delivering good radiation performance on the hand phantoms.

Optionally, when switching to a third capacitor with a smaller capacitance in the third tuning component of the antenna is performed, the first resonance shifts toward higher frequencies. Optionally, when switching to a second capacitor with a smaller capacitance in the second tuning component is performed, the second resonance shifts toward higher frequencies. In this way, specific implementations of adjusting the DM mode and the CM mode are provided. In different implementation scenarios of the solution, the third capacitors and the second capacitor may be flexibly disposed depending on a need, as so to achieve good radiation in the current scenarios.

Optionally, the terminal antenna is disposed on a long side of the electronic device.

Optionally, a length of the first radiator is greater than a ¼ wavelength of the operating band, and less than a ½ wavelength of the operating band.

According to a second aspect, an electronic device is provided. A terminal antenna according to any one of the first aspect and the possible designs thereof is disposed in the electronic device. When the electronic device transmits or receives signals, the signals are transmitted or received through the terminal antenna.

It should be understood that the technical features of the technical solution provided in the foregoing second aspect can all correspond to the technical solutions provided in the first aspect and the possible designs thereof. Therefore, similar beneficial effects can be achieved. Details are not described herein again.

### BRIEF DESCRIPTION OF THE DRAWINGS

FIG. 1 is a diagram of positions at which an antenna is disposed in a mobile phone;

FIG. 2 is a diagram of a left-handed antenna disposed on a side;

FIG. 3 is a diagram of a left-handed antenna disposed on a side;

FIG. 4 is a diagram of a current loop antenna disposed on a side;

FIG. 5 is a diagram of a hand only scenario;

FIG. 6 is a diagram of an S parameter simulation when a left-handed solution is used for a side antenna;

FIG. 7 is a diagram of an S parameter simulation when a current loop solution is used for a side antenna;

FIG. 8 is a diagram of a finger of a hand phantom blocking a gap;

FIG. 9 is a diagram of a simulation when a finger blocks a gap in a left-handed antenna solution;

FIG. 10 is a diagram of a simulation when a finger blocks a gap in a current loop antenna solution;

FIG. 11 is a logical diagram of an antenna solution according to an embodiment of this application;

FIG. 12 is a logical diagram of an antenna solution according to an embodiment of this application;

FIG. 13 is a logical diagram of an antenna solution according to an embodiment of this application;

FIG. 14 is a logical diagram of an antenna solution according to an embodiment of this application;

FIG. 15A is a logical diagram of an antenna solution according to an embodiment of this application;

FIG. 15B is a logical diagram of an antenna solution according to an embodiment of this application;

FIG. 16 is a diagram of an S parameter simulation of an antenna solution according to an embodiment of this application;

FIG. 17 is a diagram of a current simulation of an antenna solution according to an embodiment of this application;

FIG. 18 is a diagram of a current simulation of an antenna solution according to an embodiment of this application;

FIG. 19 is a diagram of an electric field simulation of an antenna solution according to an embodiment of this application;

FIG. 20 is a diagram of an electric field simulation of an antenna solution according to an embodiment of this application;

FIG. 21 is a diagram of an S parameter simulation of an antenna solution according to an embodiment of this application;

FIG. 22 is a diagram of an S parameter simulation of an antenna solution according to an embodiment of this application;

FIG. 23 is a logical diagram of an antenna solution according to an embodiment of this application;

FIG. 24 is a logical diagram of an antenna solution according to an embodiment of this application;

FIG. 25 is a logical diagram of an antenna solution according to an embodiment of this application; and

FIG. 26 is a diagram of an S parameter simulation of an antenna solution according to an embodiment of this application.

### DETAILED DESCRIPTION

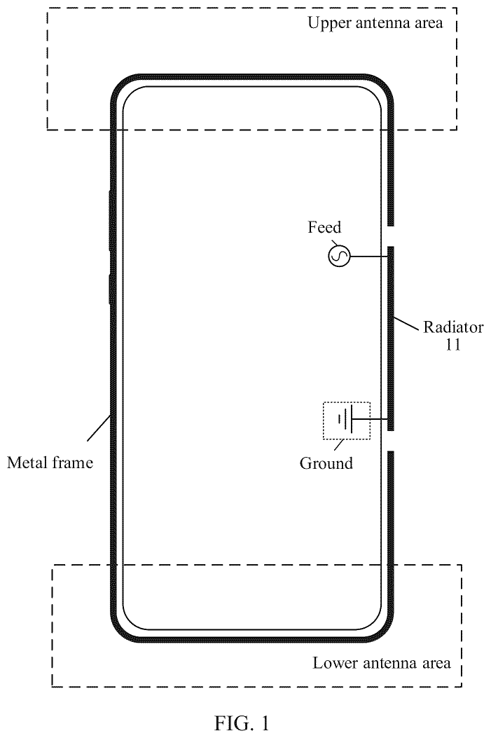

An antenna may be disposed in an electronic device and be configured to implement a wireless communication function. Referring to FIG. 1, a mobile phone is used as an example of an electronic device. A conventional antenna may be disposed at the top and/or bottom of the electronic device. Corresponding to FIG. 1, an antenna at the top may be disposed in an upper antenna area shown in FIG. 1. Correspondingly, an antenna at the bottom may be disposed in a lower antenna area shown in FIG. 1.

However, with development of electronic devices, a screen-to-body ratio is becoming higher, and a quantity of antennas is increasing. Thus, space of an upper antenna area and a lower antenna area usually cannot meet an antenna disposing requirement. Therefore, in some implementations, an antenna may be disposed on a side of an electronic device (for example, the mobile phone shown in FIG. 1).

In the example in FIG. 1, the mobile phone with an architecture of a metal frame is used as an example. Then, the metal frame may be reused as a radiator of an antenna disposed on a side, thereby saving overhead for disposing a separate antenna radiator in small space. As shown in FIG. 1, based on a required length of the antenna radiator (for example, a length of a radiator 11), gaps that penetrate from inside to outside are properly provided on the metal frame, so that a separate metal segment is obtained and used as the radiator 11. In the example in FIG. 1, a schematic illustration of electrical connections of the antenna disposed on the side (referred to as a side antenna for short) is also provided.

In this example, the antenna radiator may be the radiator 11. One end of the radiator 11 may be coupled (that is, directly connected or indirectly connected) to a feed, and the other end of the radiator 11 is coupled to a ground. The antenna architecture shown in FIG. 1 may be used to cover a low band (for example, 700 MHz to 960 MHz), a medium band (for example, 1710 MHz to 2170 MHz), a high band (for example, 2300 MHz to 2700 MHz), and at least part of other wireless communication frequency bands. In the following examples, an example in which a side antenna is configured to cover a low band is used.

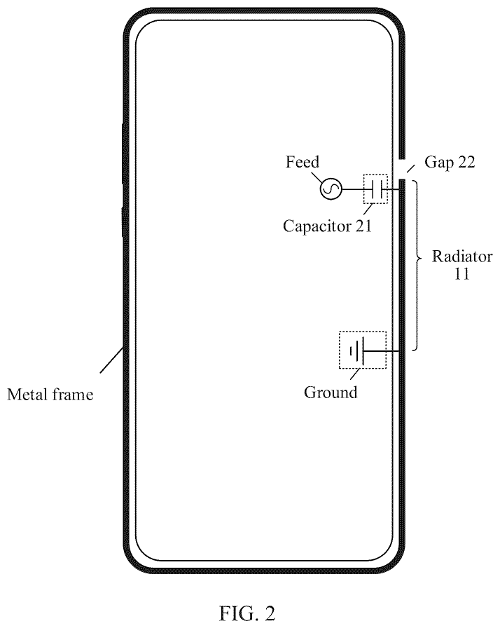

As a possible implementation, FIG. 2 shows a specific implementation of an antenna solution with the antenna architecture shown in FIG. 1. In this example, a left-handed antenna may be used as a side antenna to cover at least one of low bands (such as B28, B5, and/or B8).

In the solution shown in FIG. 2, a metal frame may be provided with a gap 22 that penetrates from inside to outside. On a side of the gap 22, the metal frame may be coupled to a feed. For example, one end of the metal frame may be coupled to the feed through a capacitor 21. A part that is of the metal frame and that is away from the gap 22 may be grounded. A length of a metal segment between a ground point and the gap 22 may be determined depending on an operating band to be covered.

In this example, the capacitor 21 may also be referred to as a left-handed capacitor. Based on disposing of the left-handed capacitor, currents in a same direction can be excited to form on a radiator 11 (that is, the metal segment between the gap 22 and the ground terminal). In this way, a left-handed mode is excited for radiation. The left-handed mode can achieve, based on a small-sized radiator, a radiation effect covering a low band. It can be understood that the antenna solution working based on the left-handed mode may also be referred to as a left-handed antenna. For a specific implementation, refer to CN201380008276.8 and CN201410109571.9. Details are not described herein.

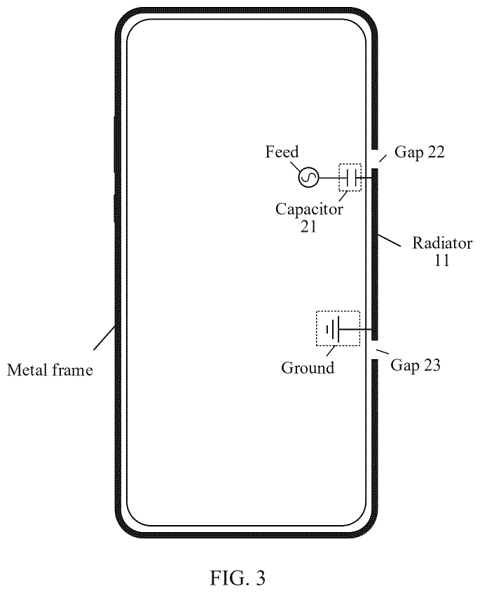

In the left-handed antenna implementation shown in FIG. 2, a gap that penetrates from inside to outside may not be provided at the ground terminal. In some other left-handed antenna implementations, as shown in FIG. 3, a gap 23 that penetrates from inside to outside may further be provided near a ground terminal of a left-handed antenna. A corresponding radiator 11 of the left-handed antenna may be a metal segment between a gap 22 and the gap 23.

FIG. 2 and FIG. 3 show the specific implementations of using a left-handed antenna as a side antenna. In some other implementations, other types of antennas may alternatively be used to implement disposing of a side antenna.

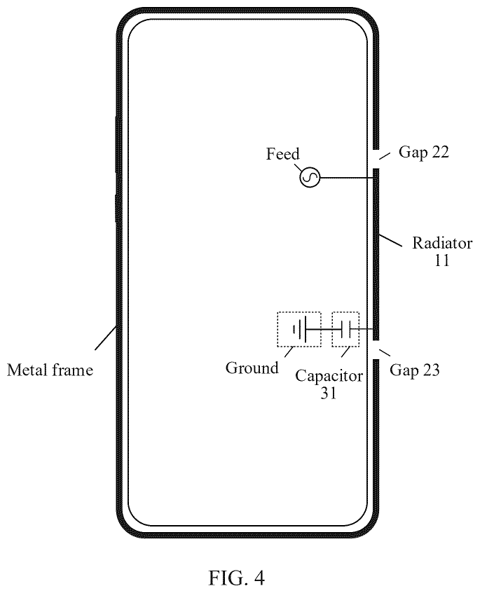

For example, FIG. 4 is a diagram of disposing of another side antenna. In this example, the side antenna may be implemented by using a current loop antenna. For specific disposing of the current loop antenna, refer to CN202110961752.4, CN202110962491.8, CN202110963510.9, 202110961755.8, and other patents related to a current loop antenna.

As an example, as shown in FIG. 4, in this example, an antenna radiator 11 may include a metal segment between a gap 22 and a gap 23 that penetrate from inside to outside of a frame. An end that is of the metal segment and that is close to the gap 22 may be connected to a feed. An end that is of the metal segment and that is close to the gap 23 may be grounded through a capacitor 31. In some other implementations, the capacitor 31 may alternatively be disposed in series at another position of the radiator 11. In this example, based on disposing of the capacitor 31 between the feed and a ground, a magnetic field distribution with a small amplitude difference may be achieved between the radiator 11 and the reference ground, so that good radiation performance is achieved in free space.

It can be understood that a plurality of scenarios are included during actual use of an electronic device, for example, the free space scenario shown in FIG. 1 to FIG. 4. In the free space scenario, there are only a few or no dielectrics that are in space near the electronic device and that affect an antenna radiator. Corresponding antenna radiation performance may be in a good state.

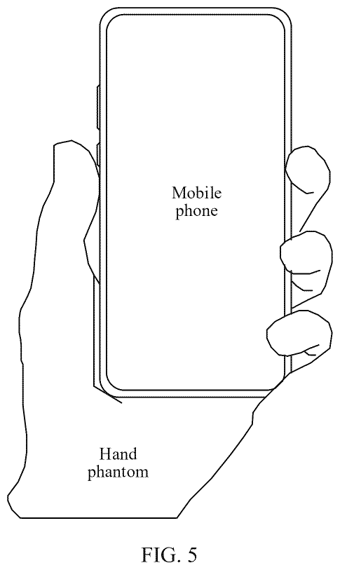

For another example, as shown in FIG. 5, in a hand only scenario in which a user holds an electronic device with a hand, the electronic device (that is, an antenna) is close to the human hand. Because a human hand causes a specific dielectric loss to electromagnetic radiation, radiation performance of the antenna is usually affected to varying degrees in the hand only scenario compared with the free space. When the user holds the electronic device with the left hand and holds the electronic device with the right hand, there may be a specific difference between operating states of the antenna on a left hand phantom and a right hand phantom because positions of the human hands (that is, the hand phantoms) with respect to the antenna are different.

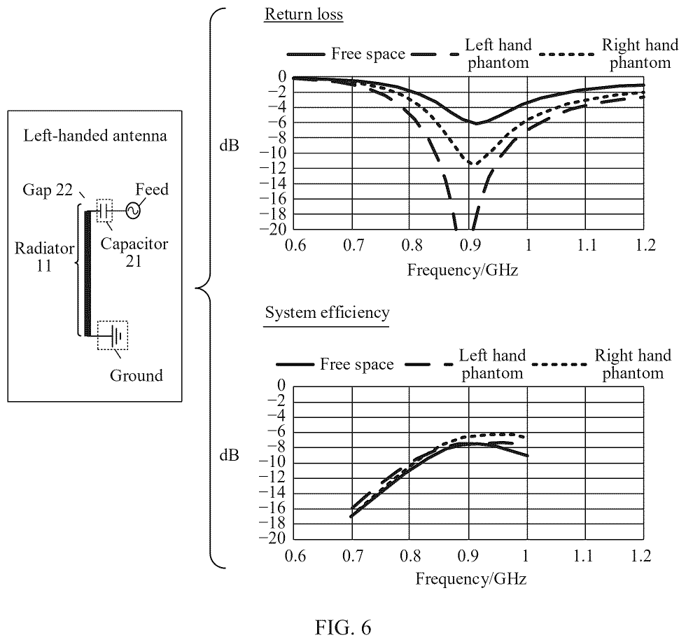

As an example, with reference to the schematic structural illustration in FIG. 2, FIG. 6 schematically illustrates an S parameter simulation of the left-handed antenna with the structure shown in FIG. 2 in the free space and in the left hand phantom and right hand phantom states. In this example, it is assumed that the left-handed antenna shown in FIG. 2 operates in the B8 frequency band (that is, 880 MHz to 960 MHz). For ease of description, only efficiencies in a low frequency-related part (that is, 700 MHz to 1 GHz) are schematically illustrated in an efficiency simulation in FIG. 6.

As shown in return losses (S11) in FIG. 6, an optimal point of the left-handed antenna in the free space is −6 dB near 900 MHz. There is no significant frequency shift on the left hand phantom and the right hand phantom compared with the free space. Corresponding to system efficiencies, it can be learned that system efficiencies of the left-handed antenna in the free space and on the left hand phantom and the right hand phantom are close, and system efficiencies at 900 MHz are all between −6 dB and −8 dB. In other words, the system efficiencies of the left-handed antenna decrease quite slightly on the hand phantoms compared with the free space. This is also an advantage of the left-handed antenna as a side antenna. However, when the left-handed antenna is disposed on a side, the system efficiencies and a bandwidth in the free space are both low.

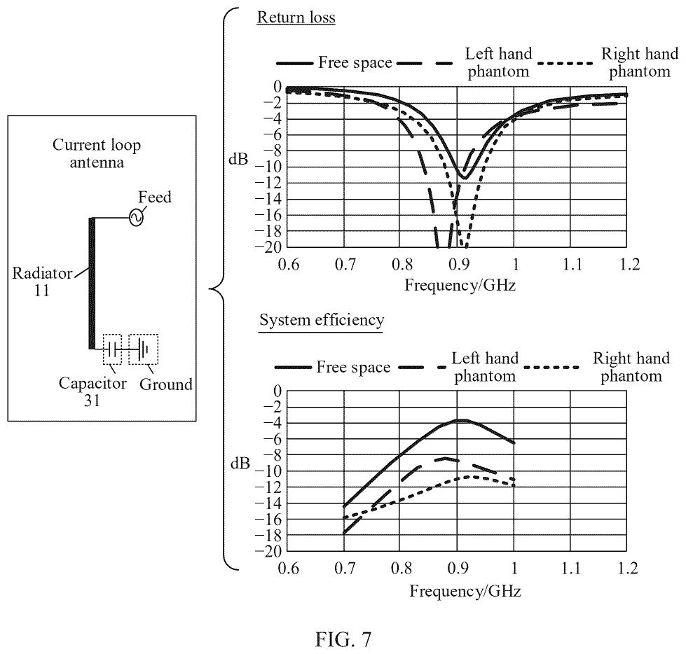

In some other examples, with reference to the schematic structural illustration in FIG. 4, FIG. 7 schematically illustrates an S parameter simulation of the current loop antenna shown in FIG. 4. In this example, it is also assumed that the current loop antenna operates in the B8 frequency band. Similar to the schematic illustration of FIG. 6, for ease of description, only efficiencies in the low frequency-related part (that is, 700 MHz to 1 GHz) are schematically illustrated in an efficiency simulation in FIG. 7.

As shown in S11 in FIG. 7, an optimal point of the current loop antenna in the free space is close to −12 dB near 900 MHz. In contrast, there is an obvious tendency to shift toward lower frequencies on the left hand phantom, whereas no significant frequency shift is caused on the right hand phantom. Corresponding to system efficiencies, a peak efficiency of the current loop antenna in the free space already exceeds −4 dB, which is significantly higher than the efficiencies of the left-handed antenna in the free space shown in FIG. 6. In addition, a higher bandwidth is available. However, according to the schematic illustration of the simulation of system efficiencies on the left hand phantom and the right hand phantom in FIG. 7, the system efficiencies of the antenna decrease significantly in the hand only scenarios. For example, a peak efficiency on the left hand phantom is less than −8 dB, and a peak efficiency on the right hand phantom is less than −10 dB. In other words, when being used as a side antenna, the current loop antenna has good performance in the free space, but poor radiation performance in the hand only scenarios.

With reference to the descriptions of FIG. 2 to FIG. 4, a gap that penetrates from inside to outside may be provided between an antenna radiator and another part of a metal frame for separation. In the examples in FIG. 6 and FIG. 7, none of the hand phantoms covers the gaps. In some other scenarios, if a hand phantom covers a gap, corresponding impact of the hand phantom further increases.

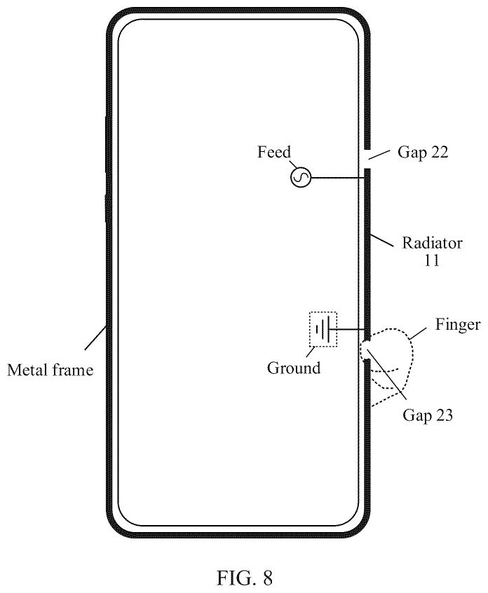

For example, referring to FIG. 8, an example in which a finger of a hand phantom covers a gap 23 near a ground terminal is used.

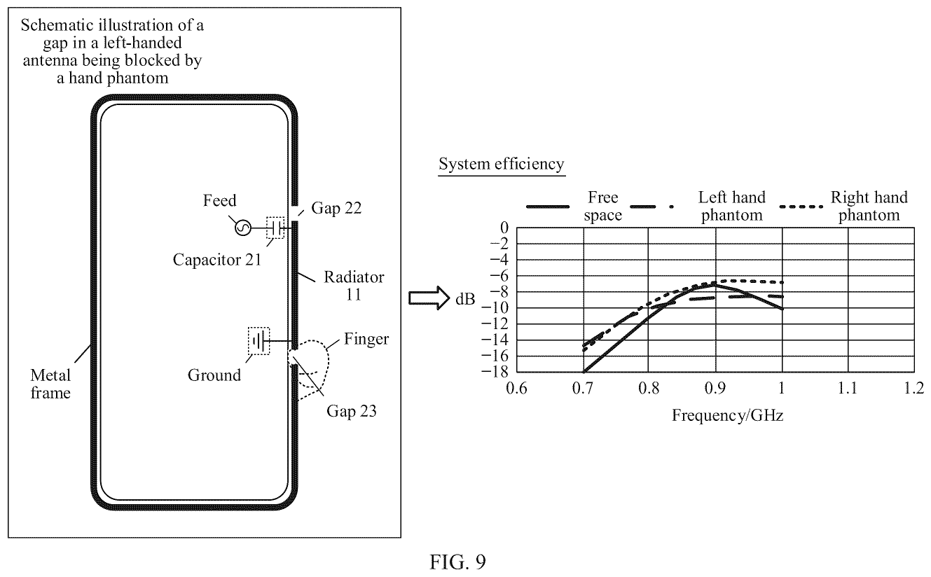

In some embodiments, FIG. 9 schematically illustrates, by using an example in which a left-handed antenna has the compositional structure shown in FIG. 3, a system efficiency simulation corresponding to a case in which a finger of a hand phantom covers the gap 23. In addition, efficiencies in the free space are provided for comparison. Similar to FIG. 6 and FIG. 7, in this example, efficiencies in the B8 frequency band of the low frequency part are still shown for description.

As shown in FIG. 9, after a finger covers the gap 23, there is still a limited decrease in efficiencies on the hand phantoms compared with efficiencies in the free space. In the antenna solution shown in FIG. 3, the radiator 11 near the gap 23 is directly grounded. Therefore, even if a finger covers the gap 23, there is still no significant impact on the efficiencies of the antenna on the hand phantoms.

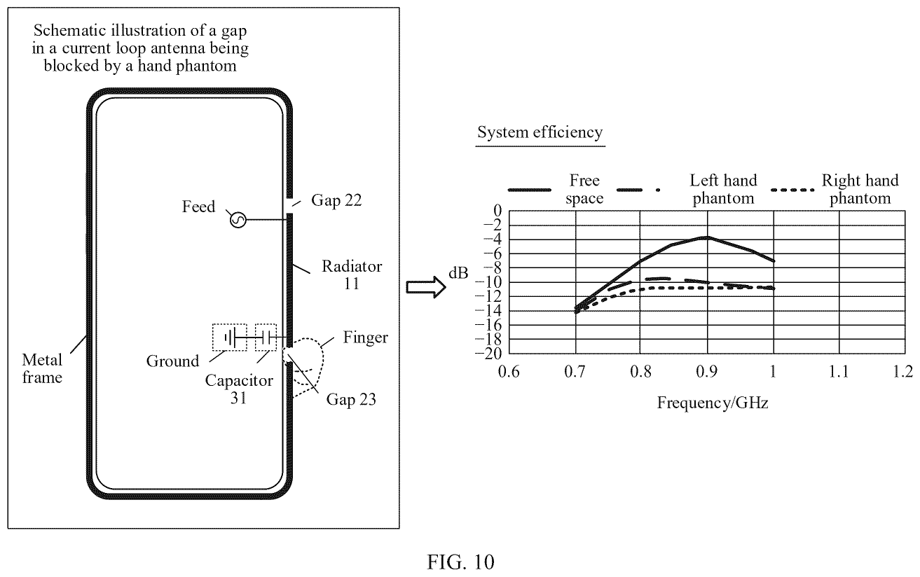

In some other embodiments, FIG. 10 schematically illustrates, by using an example in which a current loop antenna has the composition shown in FIG. 4, a system efficiency simulation corresponding to a case in which a finger of a hand phantom covers the gap 23. In addition, efficiencies in the free space are provided for comparison. Similar to FIG. 6 and FIG. 7, in this example, efficiencies in the low frequency part are still shown for description.

As shown in FIG. 10, compared with the simulation result in FIG. 7, efficiencies on the hand phantoms significantly decrease after a finger covers the gap 23. For example, near 900 MHz, an efficiency on the left hand phantom deteriorates from nearly −8 dB, which is an efficiency when the gap 23 is not covered, to −10 dB. In other words, when a finger covers a gap at an end (for example, the gap 23 that is away from the feed), performance of the current loop antenna on the hand phantoms further deteriorates.

In all the foregoing implementations of a side antenna, an example in which a side of a metal frame is reused as an antenna radiator is used for description. It can be understood that when a left-handed antenna or a current loop antenna is produced and implemented in other manners (such as an FPC antenna and an LDS antenna), the similar issues also exist.

In conclusion, among current solutions for implementing a side antenna, system efficiencies decrease slightly on the hand phantoms, but performance is poor in the free space in some solutions (for example, the left-handed antennas shown in FIG. 2 and FIG. 3); performance is good in the free space, but system efficiencies decrease significantly on the hand phantoms (especially in the hand only scenarios where a finger covers a gap) in some other solutions, for example, the current loop antenna shown in FIG. 4.

Based on this, an embodiment of this application provides an antenna solution, which can deliver both good performance in free space and a slight decrease on hand phantoms, that is, good radiation performance on the hand phantoms is also delivered. When the antenna solution is disposed in an electronic device as a side antenna, the electronic device is enabled to have a good wireless communication capability in both the free space scenario and the hand only scenarios.

The antenna solution provided in this embodiment of this application is described below in detail with reference to accompanying drawings.

It should be noted that the antenna solution provided in this embodiment of this application may be applied to an electronic device, for example, a terminal electronic device. Correspondingly, the antenna solution provided in this application may also be referred to as a terminal antenna.

In different implementations, the electronic device may include at least one of a mobile phone, a foldable electronic device, a tablet computer, a desktop computer, a laptop computer, a handheld computer, a notebook computer, an ultra-mobile personal computer (UMPC), a netbook, a cellular phone, a personal digital assistant (PDA), an augmented reality (AR) device, a virtual reality (VR) device, an artificial intelligence (AI) device, a wearable device, a vehicle-mounted device, a smart household device, or a smart city device. A specific type of the electronic device is not specially limited in this embodiment of this application.

As a possible implementation, the electronic device used in this embodiment of this application may include a processor, an external memory interface, an internal memory, a universal serial bus (USB) interface, a charging management module, a power management unit, a battery, an antenna 1, an antenna 2, a mobile communication module, a wireless communication module, an audio module, a speaker, a phone receiver, a microphone, a headset jack, a sensor module, a key, a motor, an indicator, a camera module, a display screen, a subscriber identification module (SIM) card interface, and the like. The sensor module may include a pressure sensor, a gyro sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

A mobile phone is used as an example of the electronic device. The terminal antenna provided in this embodiment of this application can be disposed on a long side of the mobile phone, corresponding to a side antenna in the foregoing examples, so as to deliver good radiation performance in the free space and on the hand phantoms.

In different implementations, specific implementations of the terminal antenna may be different. In some embodiments, a metal frame of the electronic device may be fully or partially reused as a radiator of the terminal antenna. In some other embodiments, the radiator of the terminal antenna may alternatively be implemented in a form of a flexible printed circuit (FPC), metal frame diecasting for anodicoxidation (MDA), or the like. A specific form for implementing the radiator of the terminal antenna is not limited in this embodiment of this application.

In the following examples, that a metal frame is reused as an antenna radiator is used as an example for description.

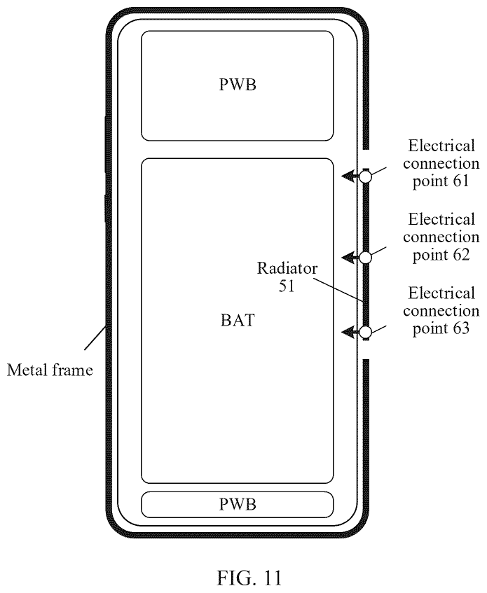

For example, FIG. 11 is a schematic illustration of an electronic device according to an embodiment of this application. In this example, the electronic device may be a mobile phone.

As shown in FIG. 11, in the electronic device, a printed wiring board (PWB), a battery (BAT), and another PWB may be disposed from top to bottom. The PWB disposed above the battery may be referred to as a primary PWB, and the PWB below the battery may be referred to as a secondary PWB. The primary PWB and the secondary PWB may be configured as carriers of other electrical devices in the electronic device, and various components are interconnected by using electrical connection lines. In addition, the primary PWB and the secondary PWB together with a metal middle frame (if any) of the electronic device may further collectively make up a reference ground for other electronic components in the electronic device.

In this example, the electronic device has an architecture of a metal frame. The metal frame is provided with one or more gaps that penetrate from inside to outside, thereby breaking the metal frame into a plurality of separate metal segments. In some implementations, a side of the electronic device may be broken by two penetrating gaps, to obtain a metal segment with a length less than a ½ wavelength of an operating band of an antenna and greater than a ¼ wavelength of the operating band of the antenna. The metal segment may correspond to a radiator 51 shown in FIG. 11, and is used as the radiator in the antenna solution provided in this embodiment of this application. As shown in FIG. 11, a projection that is of the radiator 51 in this example and that is in a central direction of the electronic device may include at least a part that falls on the battery. It can be understood that, due to significant impact of a battery on an antenna, the antenna is usually not disposed near the battery (for example, a position of the radiator 51). However, even if the antenna solution provided in this embodiment of this application is disposed near the battery, good radiation performance can also be achieved in the free space and on the hand phantoms. In some implementations, the two gaps that are used to separate the radiator 51 from the metal frame and that are at two ends may be a first gap and a second gap.

It should be noted that, in the foregoing example, the length of the radiator 51 is limited to be less than the ½ wavelength of the operating band of the antenna and greater than the ¼ wavelength of the operating band of the antenna. The length of the radiator is not necessarily the physical length of the radiator. In some implementations, the length may be a length obtained through conversion by using an electrical loss parameter such as a dielectric constant or a loss tangent angle of a material that makes up the metal frame, or the length may be an electrical strength. The same applies in the following.

As shown in FIG. 11, the radiator 51 may be provided with at least three electrical connection points, for example, an electrical connection point 61, an electrical connection point 62, and an electrical connection point 63. The electrical connection point 61, the electrical connection point 62, and the electrical connection point 63 may be configured to be coupled to a feed, be grounded, and the like, respectively. Thus, during operation of the antenna, feed signals may be fed into the radiator 51 for excitation. In addition, based on proper grounding and disposing of other components, a required mode is excited. For example, a common mode (CM) and a differential mode (DM) are excited. In some implementations, the electrical connection point 61 may correspond to a first electrical connection point, the electrical connection point 62 may correspond to a second electrical connection point, and the electrical connection point 63 may correspond to a third electrical connection point.

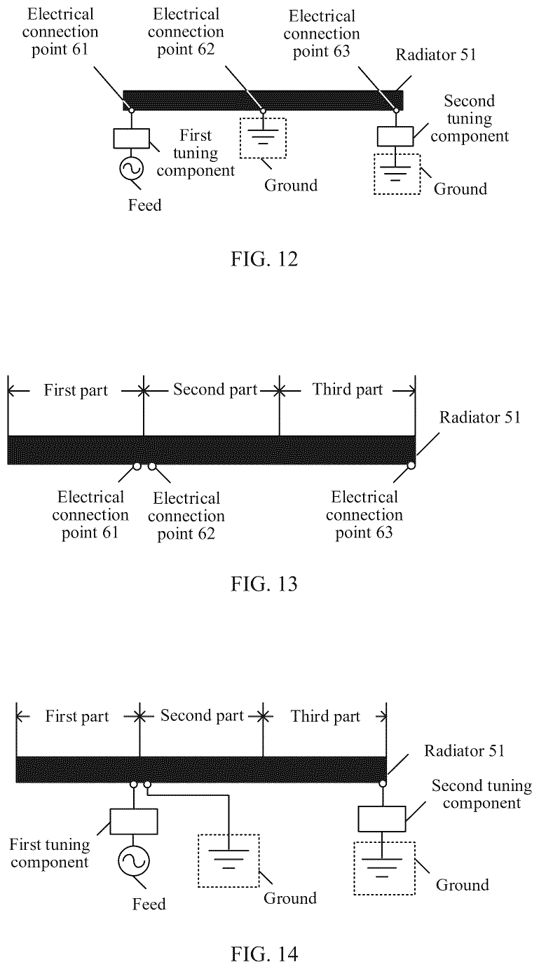

As a specific example, FIG. 12 is a logical diagram of an antenna according to an embodiment of this application. This example provides an example of specific function settings of the electrical connection points.

As shown in FIG. 12, the electrical connection point 61 may be coupled to the feed for inputting feed signals. In some embodiments, a first tuning component may further be disposed between the electrical connection point 61 and the feed. The first tuning component may be a first capacitor.

In this example, the electrical connection point 62 may be grounded. In some other embodiments, before the electrical connection point 62 is grounded, an inductor or another tuning component (not shown in the figure) may further be disposed, and is configured to tune an electrical strength of a current that returns from the radiator to a ground through the electrical connection point 62.

The electrical connection point 63 may be grounded through a second tuning component. The second tuning component may be configured to tune an electrical parameter of a current that returns from the radiator to the ground through the electrical connection point 63.

In the examples shown in FIG. 11 and FIG. 12, the electrical connection point 61 to the electrical connection point 63 are sequentially provided on the radiator 51. In some embodiments, as shown in FIG. 13, the three electrical connection points may be located in three parts of the radiator 51, respectively. As shown in FIG. 13, the radiator 51 may be equally divided into the three parts, which are a first part, a second part, and a third part in sequence in a direction from the feed to the ground. The second part is located between the first part and the third part. Lengths of the first part, the second part, and the third part are the same. The electrical connection point 61 may be provided in the first part of the radiator 51, the electrical connection point 62 may be provided in the second part of the radiator 51, and the electrical connection point 63 may be provided in the third part of the radiator 51.

In different embodiments, positions of the electrical connection points in the corresponding parts of the radiator 51 may be flexibly adjusted.

In some embodiments, as shown in the example in FIG. 12, the three electrical connection points may be provided separately from one another. For example, the electrical connection point 61 may be provided in the first part of the radiator 51, and provided at an end position that is of the first part and that is away from the second part; the electrical connection point 62 may be provided at any position of the second part (for example, a middle position or either end of the second part), and preferably, the electrical connection point 62 is provided at the middle position of the second part; and the electrical connection point 63 may be provided at an end position that is of the third part and that is away from the second part.

In some other embodiments, as shown in FIG. 13, any two of the three electrical connection points may alternatively be provided close to each other. With reference to FIG. 13, the electrical connection point 61 may be provided at an end that is of the first part of the radiator 51 and that is close to the second part; the electrical connection point 62 may be provided at an end that is of the second part and that is close to the first part; and the electrical connection point 63 may be provided at any position of the third part, for example, the end that is away from the second part.

It can be understood that FIG. 12 and FIG. 13 are merely two examples of positions at which the electrical connection points are provided on the radiator. In some other embodiments, the electrical connection points may alternatively be provided at other positions that are of their respective corresponding parts of the radiator 51. Specific positions of the electrical connection points are not limited in this embodiment of this application.

For both implementations of coupling the electrical connection points to the feed and the ground when the electrical connection points are provided at positions in different manners, refer to the example in FIG. 12. That is, the electrical connection point 61 is coupled to the feed, the electrical connection point 62 is coupled to the ground, and the electrical connection point 63 is coupled to the ground.

For example, the provision of the electrical connection points at the positions shown in FIG. 14 is used as an example. Referring to FIG. 14, the electrical connection point 61 provided in the first part and the electrical connection point 62 provided in the second part are provided close to each other. In this way, the feed may be disposed near a ground point corresponding to the electrical connection point 62. In addition, another setting may further be configured for the end that is of the radiator 51 and that is away from the feed, to couple the electrical connection point 63 to the ground.

In the following examples, the provision of the electrical connection points shown in FIG. 12 (that is, the electrical connection point 61 and the electrical connection point 63 are provided at the two ends of the radiator 51, and the electrical connection point 62 is provided at any position of the second part) is used as an example. In different implementations, specific implementations of the first tuning component and the second tuning component may be different.

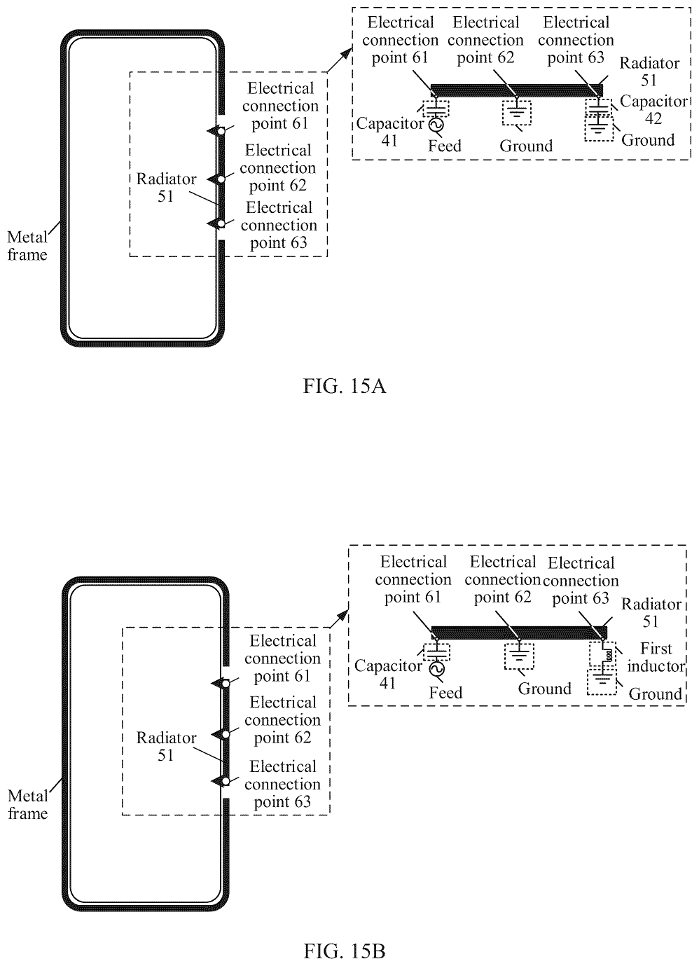

Referring to FIG. 15A, in this example, the first tuning component and the second tuning component each may be implemented by using a capacitor. For example, as shown in FIG. 15A, the first tuning component may include a capacitor 41, and the second tuning component may include a capacitor 42. In some implementations, the capacitor 41 may correspond to the first capacitor, and the capacitor 42 may correspond to a second capacitor. Preferably, the capacitor 41 and the capacitor 42 are lumped capacitors with fixed capacitances.

In some embodiments, the capacitor 41 may be configured in correspondence with a left-handed capacitor. For example, the capacitor 41 may be configured as a capacitor whose capacitance is less than 5 pF, so as to excite at least part of the radiator 51 to radiate based on a left-handed mode.

The capacitance of the capacitor 42 may be selected depending on the operating band. For example, when the operating band of the antenna is a low band, the capacitance of the capacitor 42 may be included in a range of 0 pF to 8 pF; and when the operating band of the antenna is a medium band and/or a high band, the capacitance of the capacitor 42 may be included in a range of 0 pF to 5 pF.

It can be understood that implementing a function of the second tuning component by using the capacitor 42 shown in FIG. 15A is merely an example. Through grounding of an end of the radiator 51 by disposing the capacitor 42, the differential mode DM mode can be excited on the radiator 51.

In some other embodiments, as shown in FIG. 15B, the function of the second tuning component may alternatively be implemented by using an inductor. In some implementations, the inductor in the second tuning component may also be referred to as a first inductor. When the operating band of the antenna is a low band, an inductance of the first inductor may be included in a range of 10 nH to 82 nH; and when the operating band of the antenna is a medium band and/or a high band, an inductance of the first inductor may be included in a range of 5 nH to 27 nH.

An implementation of the antenna shown in FIG. 15A is used as an example. The following describes, with reference to a simulation, radiation performance that can be achieved by the antenna.

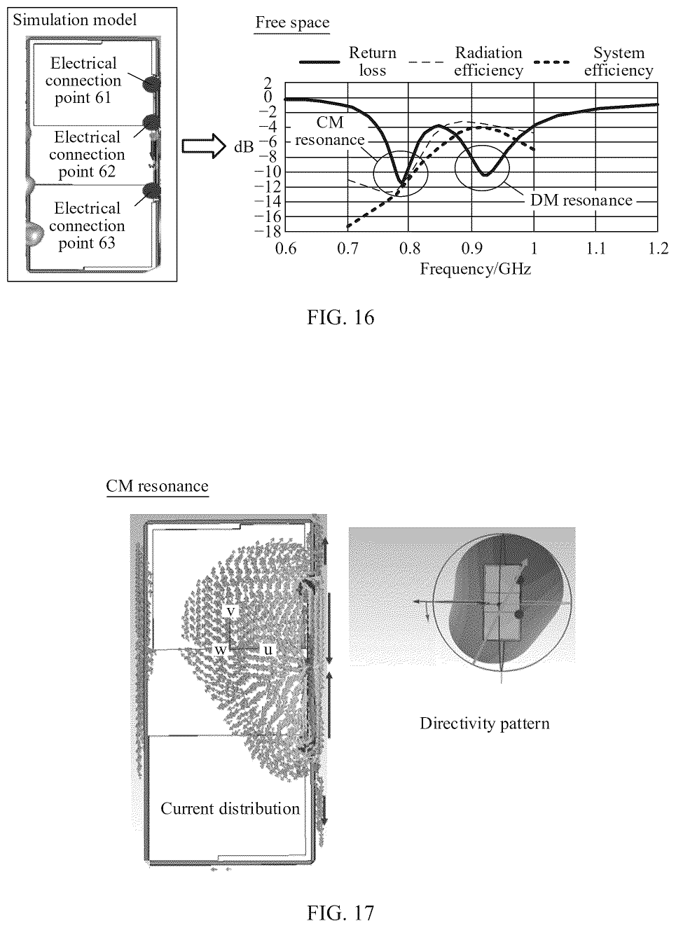

For example, it is assumed that the antenna solution shown in FIG. 15A is applied to a mobile phone as a side antenna. As shown in FIG. 16, three electrical connection points provided from top to bottom of the side antenna are the electrical connection point 61, the electrical connection point 62, and the electrical connection point 63. The connections between the electrical connection points and the feed/ground are shown in FIG. 15A.

The simulation is performed by using an example in which dimensions of the entire mobile phone are 152×75×5 (mm), an antenna clearance is 1 mm, and an antenna radiator (that is, the radiator 51) has a length of 77.5 mm, a width of 3.5 mm, and a height of 5 mm.

As shown in FIG. 16, an S parameter simulation result of the antenna model in the free space is provided. From a perspective of return loss, two resonances can be excited on the antenna simultaneously: a CM resonance located on a low frequency side and a DM resonance located on a high frequency side. The DM resonance may be mainly used to cover the operating band of the antenna in the free space. For example, the operating band of the antenna may include a B8 frequency band of low frequencies in this example. It can be understood that a main body of the CM resonance is located in a low frequency direction of the B8 frequency band, but a low-frequency part is lower than the B8 frequency band in the free space under a combined action of the CM resonance and the DM resonance. Therefore, the CM resonance also contributes to low-frequency radiation in the free space to some extent.

From a perspective of efficiency, FIG. 16 schematically illustrates both optimal efficiencies that can be achieved when all frequencies are fully matched (that is, radiation efficiencies), and efficiencies when a current port is matched (that is, system efficiencies). In the B8 frequency band, for example, near 900 MHz, a radiation efficiency exceeds −6 dB, and a system efficiency reaches −6 dB. Therefore, the antenna solution shown in FIG. 15A can achieve good radiation performance in the free space.

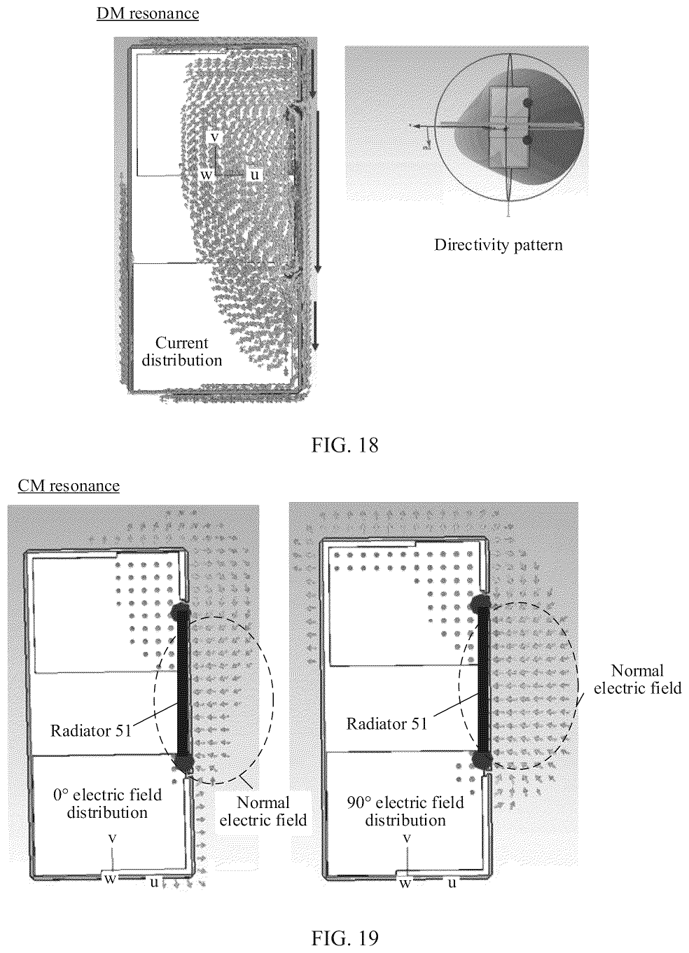

FIG. 17 and FIG. 18 provide schematic illustrations of current simulations and directivity patterns of the CM resonance and the DM resonance, respectively. A darker color corresponds to a stronger current/gain.

FIG. 17 schematically illustrates the current simulation and the directivity pattern of the CM resonance. As shown in FIG. 17, in the CM resonance mode, currents converge from both ends to a middle on the antenna radiator, and a characteristic of current reversal is shown on the radiator, thereby corresponding to a typical current distribution of the CM. In a current distribution on the ground, the CM resonance mode can excite significant, obliquely upward and obliquely downward currents on the ground. Thus, based on orthogonal decomposition, longitudinal currents cancel one another out, and transverse currents are superimposed on one another. Therefore, the CM resonance mode can effectively excite the transverse currents on the ground. Corresponding to the directivity pattern, the directivity pattern shown in FIG. 17 shows an obliquely upward direction.

FIG. 18 schematically illustrates the current simulation and the directivity pattern of the DM resonance. As shown in FIG. 18, in the DM resonance mode, currents flow from one end to the other end on the antenna radiator without reversing, and the currents are in the same direction, thereby corresponding to a typical current distribution of the DM. In a current distribution on the ground, the DM resonance mode can excite significant longitudinal currents on the ground. Corresponding to the directivity pattern, a transverse gain distribution is significantly stronger than a longitudinal gain distribution.

It can be understood that low-frequency radiation is mainly performed through a ground. In this example, when the DM mode works, the significant longitudinal currents on the ground can be excited, for example, a longitudinal eigenmode on the ground is effectively excited. A mobile phone is used as an example of the electronic device. A longitudinal dimension (that is, a length of a long side) of the mobile phone is close to 150 mm, and the length is close to a ½ wavelength of a low frequency. Therefore, through excitation of the longitudinal eigenmode on the ground, low-frequency radiation performance can be significantly improved. Based on this, the antenna solution provided in this application can excite the longitudinal eigenmode on the ground in the DM resonance, thereby achieving good radiation performance in the free space.

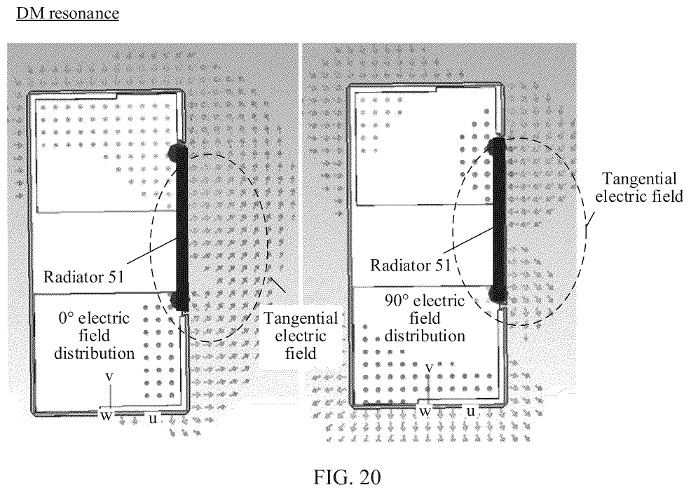

FIG. 19 and FIG. 20 provide schematic illustrations of electric field simulations of the CM resonance and the DM resonance, respectively. A darker color indicates a stronger electric field.

FIG. 19 shows an electric field distribution in the CM resonance mode. At both 0° and 900 phases, the radiator 51 may radiate, to external space, a normal electric field perpendicular to the radiator. It is well known to a person skilled in the art that a human body significantly absorbs a tangential electric field, but does not significantly absorb a normal electric field. In other words, the CM mode excited in this application does not cause significant performance deterioration due to approaching of the hand phantoms. Therefore, in this application, radiation performance can be improved on the hand phantoms in the CM resonance mode.

FIG. 20 shows an electric field distribution in the DM resonance mode. At both 0° and 900 phases, the radiator 51 may radiate, to external space, a tangential electric field perpendicular to the radiator. It is well known to a person skilled in the art that a human body significantly absorbs a tangential electric field. However, the excited DM mode is enabled, through design, to produce the longitudinal eigenmode on the ground in the present disclosure. Through excitation of the longitudinal eigenmode on the ground, low-frequency radiation performance can be significantly improved, so that radiation performance in the DM mode is improved, and better radiation performance is achieved. In addition, significant absorption is caused in the DM mode by the hand phantoms compared with the DM mode in the free space.

With reference to the descriptions of FIG. 19 and FIG. 20, when the antenna solution shown in FIG. 15A works in the free space, the antenna solution can provide a good radiation capability in the DM mode; in the hand only scenarios, the CM mode can effectively reduce absorption by the hand phantoms, improving a radiation capability of the antenna in the hand only scenarios.

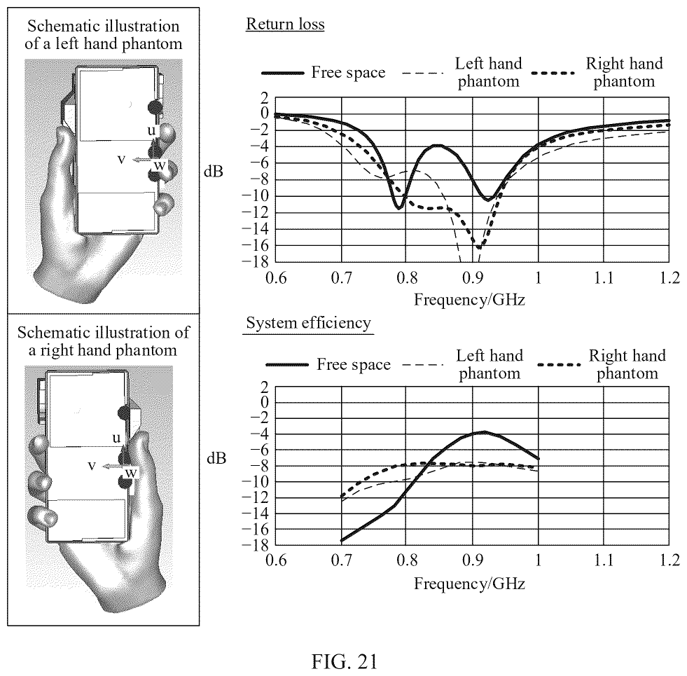

FIG. 16 already provides the schematic illustration of the efficiency simulation in the free space, corresponding to the electric field/current distributions shown in FIG. 17 to FIG. 20. FIG. 21 provides a schematic illustration of an S parameter simulation of the antenna solution shown in FIG. 15A on the hand phantoms for a continued description.

As shown in FIG. 21, in the CM mode close to a low frequency direction, return losses do not change significantly on the hand phantoms. The resonances change significantly in the corresponding DM mode on both the left hand phantom and the right hand phantom. It can be understood that, after the hand phantoms are added, the resonances in the DM mode become deeper, corresponding to larger absorption by the hand phantoms. Therefore, the hand phantoms have large impact on the DM mode.

From a perspective of system efficiency, in this example, because the CM mode is insensitive to the hand phantoms, efficiencies in the operating band (B8) on the hand phantoms are guaranteed. Efficiencies in the B8 in the free space are covered by the DM mode. As shown in FIG. 21, in this solution, an average efficiency in the B8 reaches −4.6 dB in the free space, and an efficiency is −7.8 dB on the left hand phantom and −7.9 dB on the right hand phantom. Efficiencies on the left and right hands are balanced, and there is only a decrease of 3.3 dB.

With reference to the foregoing descriptions of FIG. 8 to FIG. 10, in the current antenna solutions, if a finger blocks a gap (for example, the gap 23) at an end of an antenna in the hand only scenarios, a more significant decrease is caused on the hand phantoms. The technical solutions provided in this embodiment of this application (for example, any one of the antenna solutions in FIG. 11 to FIG. 15B) can effectively overcome this problem.

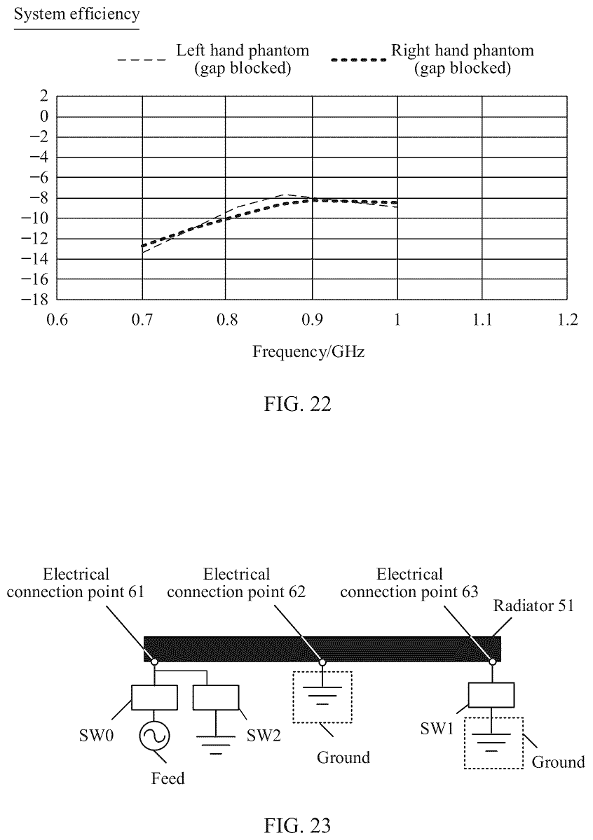

For example, FIG. 22 is a schematic illustration of a simulation of efficiencies on the left and right hands when a gap is blocked by the hand phantoms. Compared with the normal hand only environment shown in FIG. 21, when the gap is blocked by the hand phantoms, there is no significant change in system efficiencies on the left and right hand phantoms. However, in an existing antenna solution (for example, the current loop antenna), as illustrated in FIG. 7 and FIG. 10, the system efficiencies significantly deteriorate again when the gap is blocked by the hand phantoms.

Based on the foregoing description of FIG. 15A, it can be learned that the antenna solution shown in FIG. 15A can deliver good radiation performance in the free space in the DM mode, and can improve efficiencies on the hand phantoms through coverage by the CM mode.

Specifically, with reference to FIG. 15A to FIG. 22, Table 1 shows a comparison of efficiencies at high, medium, and low channels in the antenna solution implementations when the operating band is the B8. The B8 low channel corresponds to 880 MHz, the B8 medium channel corresponds to 920 MHz, and the B8 high channel corresponds to 960 MHz.

TABLE 1

| | | | | | | Average |
|---|---|---|---|---|---|---|
| | | | | | | decrease on a |
| | | | | | | hand |
| | | | | | | phantom |
| | | | B8 | | | compared |
| | | B8 low | medium | B8 high | Average | with free |
| | Efficiency/dB | channel | channel | channel | in B8 | space |
| Antenna | Free space | −4.7 | −3.9 | −5.1 | −4.6 | N/A |
| solution | Left hand | −7.6 | −7.6 | −8.1 | −7.8 | −3.2 |
| provided in | phantom | | | | | |
| this | Right hand | −7.9 | −7.9 | −8 | −7.9 | −3.4 |
| application | phantom | | | | | |
| | Left hand | −7.9 | −8.1 | −8.5 | −8.2 | −3.6 |
| | phantom (gap | | | | | |
| | blocked) | | | | | |
| | Right hand | −8.4 | −8.2 | −8.3 | −8.3 | −3.7 |
| | phantom (gap | | | | | |
| | blocked) | | | | | |
| Current loop | Free space | −4.6 | −3.9 | −4.5 | −4.3 | N/A |
| antenna | Left hand | −8 | −7.9 | −8.6 | −8.2 | −3.8 |
| solution | phantom | | | | | |
| | Right hand | −10.9 | −9 | −8.5 | −9.5 | −5.1 |
| | phantom | | | | | |
| | Left hand | −9.6 | −10 | −10.3 | −10 | −5.6 |
| | phantom (gap | | | | | |
| | blocked) | | | | | |
| | Right hand | −10.7 | −10.8 | −10.8 | −10.8 | −6.4 |
| | phantom | | | | | |
| | (gap blocked) | | | | | |
| Left-handed | Free space | −7.9 | −7.2 | −8 | −7.7 | N/A |
| antenna | Left hand | −8.6 | −8.2 | −8 | −8.3 | −0.6 |
| solution | phantom | | | | | |
| | Right hand | −6.8 | −6.1 | −6 | −6.6 | 1.4 |
| | phantom | | | | | |
| | Left hand | −9 | −8.7 | −8.6 | −8.8 | −1.1 |
| | phantom (gap | | | | | |
| | blocked) | | | | | |
| | Right hand | −7.5 | −6.7 | −6.6 | −6.9 | 0.8 |
| | phantom (gap | | | | | |
| | blocked) | | | | | |

In the example in Table 1, the antenna solution provided in this application may be a simulation result of the antenna solution shown in FIG. 15A, the current loop antenna solution may be the antenna solution shown in FIG. 4, and the left-handed antenna solution may be the antenna solution shown in FIG. 2 or FIG. 3. It can be learned from Table 1 that, with the antenna solution provided in this application as an example for description, the antenna efficiency achieved in the B8 low-channel frequency band is −4.7 dB, the antenna efficiency achieved in the B8 medium-channel frequency band is −3.9 dB, and the antenna efficiency achieved in the B8 high-channel frequency band is −5.1 dB in the free space scenario. Therefore, the average antenna efficiency achieved in the B8 frequency band is −4.6 dB. A change occurs in a case of holding by a hand. A left hand is used as an example. In the left hand only scenario, the antenna efficiency achieved in the B8 low-channel frequency band is −7.6 dB, the antenna efficiency achieved in the B8 medium-channel frequency band is −7.6 dB, and the antenna efficiency achieved in the B8 high-channel frequency band is −8.1 dB. Therefore, the average antenna efficiency achieved in the B8 frequency band on the left hand phantom is −7.8 dB. Thus, it can be learned that, the average decrease in the antenna efficiencies on the left hand phantom compared with the antenna efficiencies in the free space is −3.2 dB, that is, −7.8 dB −(−4.6 dB). Likewise, when a user covers a gap with the left hand, that is, in the left hand only (gap blocked) scenario, the average decrease in the antenna efficiencies is −3.6 dB, compared with the antenna efficiencies in the free space. However, in the prior art, when the current loop solution is used, the average decrease in the antenna efficiencies achieved in the left hand only scenario compared with the antenna efficiencies in the free space is −3.8 dB. Compared with −3.2 in the present disclosure, the decrease on the hand phantom is not large. When the current loop solution is used, the average decrease in the antenna efficiencies achieved in the left hand only (gap blocked) scenario compared with the antenna efficiencies in the free space is −5.6 dB. The average decrease in the antenna efficiencies is 2 dB less than that of the technical solution of the present disclosure. Likewise, when the left-handed solution is used, the average antenna efficiency in the free space scenario is −7.7 dB. Compared with the average antenna efficiency −4.6 dB achieved by the present disclosure in the B8 frequency band in the free space, the antenna efficiency in the free space decreases by 3.1 dB when the left-handed solution is used. Therefore, in the left hand only scenario and the left hand only (gap blocked) scenario, the decreases on the hand phantom are not large when the left-handed solution is used. It can be learned that the efficiencies that are of the antenna solution provided in this application and that are in the free space are higher than the efficiencies of the left-handed antenna in the free space, and the efficiencies of the antenna solution of the present disclosure on the hand phantoms are higher than the efficiencies of the current loop antenna on the hand phantoms. Therefore, the antenna solution provided in this embodiment of this application and shown in FIG. 15A can deliver good radiation performance in all the different scenarios.

It can be understood that, in all the foregoing simulation examples, the antenna solution shown in FIG. 15A is used as an example. It can be understood that the antenna solution provided in any one of FIG. 11 to FIG. 14 works in a similar way to the antenna solution shown in FIG. 15A, and each can improve efficiencies on the hand phantoms in the CM mode, and provide high efficiencies in the free space in the DM mode. Therefore, the other implementations can all provide high radiation efficiencies in the various scenarios.

It should be noted that, in FIG. 15A, the capacitor 41 implements a function of the first tuning component, and the capacitor 42 implements the function of the second tuning component. With reference to the foregoing description, the first tuning component may alternatively implement the tuning function thereof by using another component. For example, as shown in FIG. 15B, the second tuning component may be an inductor or the like. Thus, an operating band is covered by using an inductor with a fixed inductance or a capacitor with a fixed capacitance.

In some other embodiments, the function of the first tuning component and/or the function of the second tuning component may further be implemented by using a switching switch that includes at least two switchable paths. When a different path is connected by using the switching switch, the antenna may be tuned by using an inductor/a capacitor on the corresponding path, to cover at least one operating band. To be specific, when the antenna needs to operate in a different wireless communication frequency band, the electronic device may control operation of the switching switch to make a corresponding path connected, to switch the operating band of the antenna to the wireless communication frequency band.

As an example, as shown in FIG. 23, the first tuning component may include an SW0. For example, the SW0 may include the capacitor 41 in the foregoing example. The second tuning component may include an SW1. A third tuning component may further be disposed on the antenna. The third tuning component is connected to the position of the electrical connection point 61 or near the electrical connection point 61. For example, the third tuning component may include an SW2. One end of the SW2 may be connected to the radiator 51, or connected to a path between the SW0 and the radiator 51. The other end of the SW2 may be connected to the ground. In this way, the SW2 may be connected to a feeder link in parallel. It should be noted that, in some other logical divisions, the SW2 may alternatively be included in the first tuning component. In the following examples, it is assumed that one end of the SW2 is connected to the electrical connection point 61, and the other end is connected to the ground.

In the example in FIG. 23, the SW1 and the SW2 each may include at least two switchable paths. Different inductors/capacitors are disposed on different switchable paths.

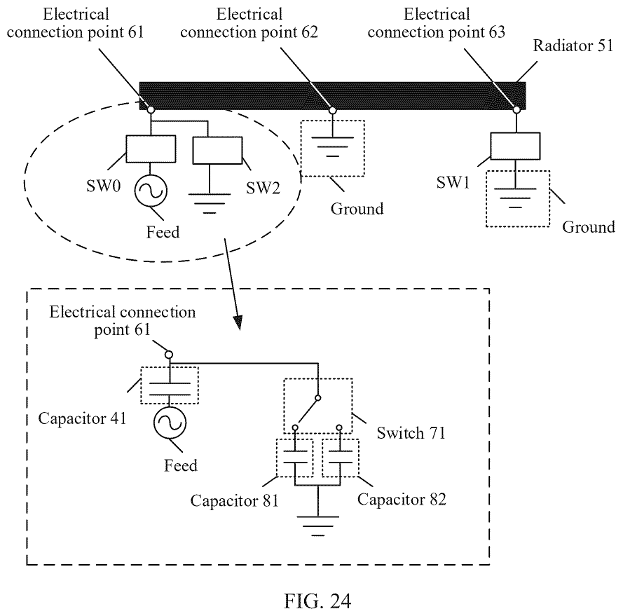

For example, it is assumed that the SW2 includes two switchable paths, and capacitors with different capacitances are disposed on the paths. As shown in FIG. 24, the SW2 may include a switch 71, a capacitor 81, and a capacitor 82. An input end included in the switch 71 is connected to the electrical connection point 61 on the radiator 51. A first output end included in the switch 71 is connected to one end of the capacitor 81, and the other end of the capacitor 81 is connected to the ground. A second output end included in the switch 71 is connected to one end of the capacitor 82, and the other end of the capacitor 82 is connected to the ground. Capacitances of the capacitor 81 and the capacitor 82 may be different. In different operation scenarios, the capacitor 81 or the capacitor 82 is connected to a feeder path through switching of the switch 71, so that a frequency band covered by the CM mode excited on the antenna is adjusted.

In some implementations, a capacitor disposed in the SW2 may also be referred to as a third capacitor. For example, both the capacitor 81 and the capacitor 82 may be referred to as third capacitors.

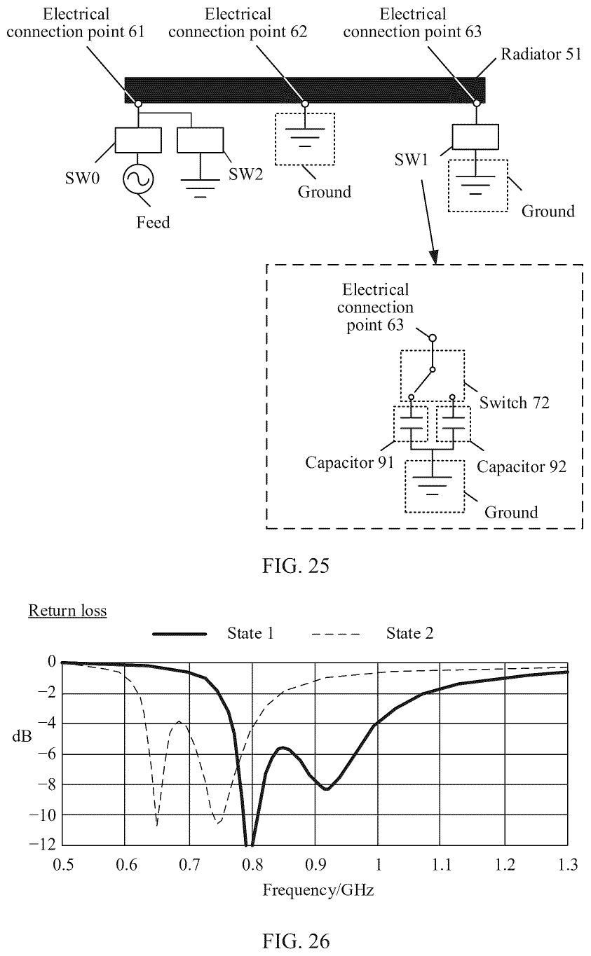

It is assumed that the SW1 includes two switchable paths, and capacitors with different capacitances are disposed on the paths. As shown in FIG. 25, the SW1 may include a switch 72, a capacitor 91, and a capacitor 92. A first input end included in the switch 72 is connected to the electrical connection point 63 on the radiator 51. A first output end included in the switch 72 is connected to one end of the capacitor 91, and the other end of the capacitor 91 is grounded. A second output end included in the switch 72 is connected to one end of the capacitor 92, and the other end of the capacitor 92 is grounded. Capacitances of the capacitor 91 and the capacitor 92 may be different. In some embodiments, the capacitances of the capacitor 91 and the capacitor 92 may be selected according to the relationships between the operating band and the capacitance of the capacitor 42 in the foregoing example. In different operation scenarios, the capacitor 91 or the capacitor 92 is connected to a ground return path through switching of the switch 72, so that a frequency band covered by the DM mode excited on the antenna is adjusted. It should be understood that, in some other embodiments, the SW1 may alternatively include at least one switchable path with an inductor. Thus, when the path is connected, a magnetic loop mode is excited on the radiator for operation. In the following example, an example in which the SW1 includes the composition shown in FIG. 25 continues to be used.

In some implementations, a capacitor disposed in the SW1 may also be referred to as a second capacitor. For example, both the capacitor 91 and the capacitor 92 may be referred to as second capacitors. In some other implementations, when the SW1 includes inductors, the inductors on various paths may all be referred to as first inductors.

In some embodiments, during adjustment of a low band covered by the antenna, if switching to a capacitor with a larger capacitance in the SW2 is performed, the corresponding CM mode shifts toward lower frequencies; if switching to a capacitor with a larger capacitance in the SW1 is performed, the corresponding DM mode shifts toward lower frequencies.

As a specific implementation, as shown in FIG. 26, a covered low frequency operating band may be adjusted through switching to different paths of both the SW2 and the SW1. In this example, the electronic device controls the switch 71 in the SW2 to connect to the capacitor 81, and controls the switch 72 in the SW1 to connect to the capacitor 91. This corresponds to a state 1 shown in the figure. In the state 1, the DM mode may cover the B8 frequency band, and a resonance frequency of the CM mode may be located in a low frequency direction of the B8 frequency band, so as to improve efficiencies in the B8 on the hand phantoms. When the antenna needs to switch to and operate in B28, the electronic device may control the switch 71 in the SW2 to connect to the capacitor 82, and control the switch 72 in the SW1 to connect to the capacitor 92. This corresponds to a state 2 shown in the figure. The capacitance of the capacitor 82 may be greater than that of the capacitor 81, and the capacitance of the capacitor 92 may be greater than that of the capacitor 91. In the state 2, the DM mode may be used to cover the B28, and the resonance frequency of the CM mode may be located in a low frequency direction of the B28 frequency band, so as to improve efficiencies in the B28 on the hand phantoms.

In this way, low band switching is implemented in the antenna solution. In different low-band operating states, both the CM mode and the DM mode can be excited on the radiator. Therefore, efficiencies can be effectively guaranteed both in the free space and on the hand phantoms.

It should be understood that, in some other embodiments, to implement wider frequency band coverage, more switchable paths may further be provided in the SW2 and/or the SW1, so as to switch to corresponding paths for operation in different scenarios.

Although this application is described with reference to specific features and embodiments thereof, apparently, various modifications and combinations may be made to them without departing from the spirit and scope of this application. Correspondingly, this specification and the accompanying drawings are merely used as exemplary descriptions of this application defined by the appended claims, and are considered as having covered any of and all of modifications, variations, combinations, or equivalents within the scope of this application. Obviously, a person skilled in the art can make various modifications and variations to this application without departing from the spirit and scope of this application. In this case, if the modifications and variations made to this application fall within the scope of the claims of this application and their equivalent technologies, this application is intended to include these modifications and variations.

1. An antenna, comprising:
a first radiator;
wherein the antenna is included in an electronic device, the electronic device is provided with a metal frame, the metal frame is provided with a first gap and a second gap, a metal segment between the first gap and the second gap forms the first radiator, and the first radiator and another metal segment outside the first gap and the second gap are not connected to each other;
wherein a first electrical connection point, a second electrical connection point, and a third electrical connection point are sequentially provided on the first radiator; and
wherein the first electrical connection point is coupled to a feed through a first tuning component, the second electrical connection point is coupled to a reference ground, and the third electrical connection point is coupled to the reference ground through a second tuning component.

2. The antenna according to claim 1, wherein the first tuning component comprises a first capacitor.

3. The antenna according to claim 2, wherein the second tuning component comprises at least one type of the following: a capacitor or an inductor.

4. The antenna according to claim 3,
wherein the second tuning component comprises at least one second capacitor, and a capacitance of the at least one second capacitor is determined depending on an operating band;
wherein when the operating band of the antenna covers low frequencies, a capacitance of the at least one second capacitor is comprised in a range of 0 pF to 8 pF; and
wherein when the operating band of the antenna covers medium-high frequencies, the capacitance of the at least one second capacitor is comprised in a range of 0 pF to 5 pF.

5. The antenna according to claim 3,
wherein the second tuning component comprises at least one first inductor, and an inductance of the at least one first inductor is determined depending on an operating band;
wherein when the operating band of the antenna covers low frequencies, an inductance of the at least one first inductor is comprised in a range of 10 nH to 82 nH; and
wherein when the operating band of the antenna covers medium-high frequencies, the inductance of the at least one first inductor is comprised in a range of 5 nH to 27 nH.

6. The antenna according to claim 5,
wherein the second tuning component comprises at least two paths, and during operation of the antenna, at least one of the at least two paths is selected, by using a switch, for connection; and
wherein one second capacitor or one first inductor is disposed on each path of the at least two paths.

7. The antenna according to claim 6, further comprising:
a third tuning component, wherein one end of the third tuning component is connected to the first electrical connection point, and the other end of the third tuning component is connected to the reference ground;
wherein the third tuning component comprises at least two third capacitors, wherein each third capacitor of the at least two third capacitors corresponds to a path, and capacitances of third capacitors on different paths are different; and
wherein during operation of the antenna, at least one path corresponding to the at least two third capacitors is selected, by using a switch, for connection.

8. The antenna according to claim 1,
wherein the first radiator is equally divided into a first part, a second part, and a third part, and the second part is located between the first part and the third part; and
wherein the first electrical connection point is provided at any position of the first part, the second electrical connection point is provided at any position of the second part, and the third electrical connection point is provided at any position of the third part.

9. The antenna according to claim 8, wherein the first electrical connection point is provided at an end that is of the first part and that is away from the second part, and the third electrical connection point is provided at an end that is of the third part and that is away from the second part.

10. The antenna according to claim 7, wherein during operation of the antenna, a first resonance and a second resonance are excited, wherein a frequency of the first resonance is lower than a frequency of the second resonance, the first resonance is excited in a common mode (CM), and the second resonance is excited in a differential mode (DM).

11. The antenna according to claim 10, wherein when switching to a third capacitor with a smaller capacitance in the third tuning component of the antenna is performed, the first resonance shifts toward higher frequencies.

12. The antenna according to claim 11, wherein when switching to a second capacitor with a smaller capacitance in the second tuning component is performed, the second resonance shifts toward higher frequencies.

13. The antenna according to claim 1, wherein the antenna is disposed on a long side of the electronic device.

14. The antenna according to claim 1, wherein a length of the first radiator is greater than a ¼ wavelength of an operating band, and less than a ½ wavelength of the operating band.

15. An electronic device, wherein the antenna according to claim 1 is disposed in the electronic device, and when the electronic device transmits or receives signals, the signals are transmitted or received through the antenna.

16. The antenna according to claim 2, wherein a length of the first radiator is greater than a ¼ wavelength of an operating band, and less than a ½ wavelength of the operating band.

17. The antenna according to claim 3, wherein a length of the first radiator is greater than a ¼ wavelength of an operating band, and less than a ½ wavelength of the operating band.

18. The antenna according to claim 4, wherein a length of the first radiator is greater than a ¼ wavelength of an operating band, and less than a ½ wavelength of the operating band.

19. The antenna according to claim 5, wherein a length of the first radiator is greater than a ¼ wavelength of an operating band, and less than a ½ wavelength of the operating band.

20. The antenna according to claim 6, wherein a length of the first radiator is greater than a ¼ wavelength of an operating band, and less than a ½ wavelength of the operating band.
